(19) United States
(12) Patent Application Publication
(10) Pub. No.: US 2004/0149517 A1
(43) Pub. Date: Aug. 5, 2004

(54) Lubricating device of external oil storage tank of self-lubricating linear sliding track

(76) Inventor: Mao-Tu Lee, Taipei Hsien (TW)

Correspondence Address: LEE MAO-TU, 235 P.O. BOX 10-69, Chung-Ho Taipei, TW

(21) Appl. No.: 10/357,102

(22) Filed: Feb. 4, 2003

(51) Int. Cl. F16N 1/00

(52) U.S. Cl. 184/5

(57) ABSTRACT

A lubricating device of an external oil storage tank of a self-lubricating linear sliding track comprises a self-lubricating means and an oil storage tank. Two sides of a sliding block body are installed respective oil storage tanks; the oil storage tank has an oil storage casing with oil-containing material therein. The oil-containing material in the oil-containing tank is not in contact with a rolling surface of a sliding track. Two ends of the oil-containing tank are opened. Lubricating oil of the oil-containing material in the oil storage tank can be transferred to the sliding track by oil-containing material in the self-lubricating means by siphon effect so as to achieve an effect of lubrication. External oil tanks are installed between two sliding seat bodies for being used for a long time and has the function of dust-proof.

### FIELD OF THE INVENTION

The present invention relates to a lubricating device of an external oil storage tank of a self-lubricating linear sliding track, the oil storage casing is made by plastic pressing molding. The oil storage casing has an oil-containing element. By siphon theory, lubricating oil is transferred to the self-lubricating means for lubricating a lubricating sliding track and a rolling element.

### BACKGROUND OF THE INVENTION

Referring to FIG. 1, a portion lubricating device is illustrated. In the prior art, two sides of a sliding body A are installed with respective lubricating means. The lubricating means is formed by end circling outer covers B, C. Lubricating elements D and E are placed in the end circling outer covers. Dust-proof covers F and G serve to seal the openings of the means. The lubricating elements D and E are in contact with a sliding track so as to provide lubricating oil to the rolling surface of the sliding track and the rolling elements.

The lubricating device contains only a little oil so that the cost for maintenance is increased.

Moreover, in the prior art lubricating device, if external lubricating elements are used. Two sides of the rolling body A have respective lubricating means and an external lubricating device. The external lubricating device is in contact with the rolling surface of the sliding track so that a great deal of the lubricating oil will flow out. As a result, the length of the lubricating devices at two sides are prolonged. Moreover, the volume is finite. Thereby, the lubricating oil provided is less.

To improve above said defect so as to provide methods for resolving the problem in the CNC tool and thus oil can be used for a longer period, the present invention present a lubricating device to improve the defect in the prior art.

### SUMMARY OF THE INVENTION

Accordingly, the primary object of the present invention is to provide a lubricating device of an external oil storage tank of a self-lubricating linear sliding track which comprises a self-lubricating means and a oil storage tank. Two sides of a sliding block body are installed respective oil storage tanks; and the oil storage tank has an oil storage casing with oil-containing material therein. The oil-containing material in the oil-containing tank is not in contact with a rolling surface of a sliding track. Two ends of the oil-containing tank are opened. Lubricating oil of the oil-containing material in the oil storage tank can be transferred to the sliding track by oil-containing material in the self-lubricating means by siphon effect so as to achieve an effect of lubrication. External oil tanks are installed between two sliding seat bodies for being used for a long time and has the function of dust-proof.

The various objects and advantages of the present invention will be more readily understood from the following detailed description when read in conjunction with the appended drawing.

### BRIEF DESCRIPTION OF THE DRAWINGS

FIG. 1 is an exploded perspective view of a prior art.

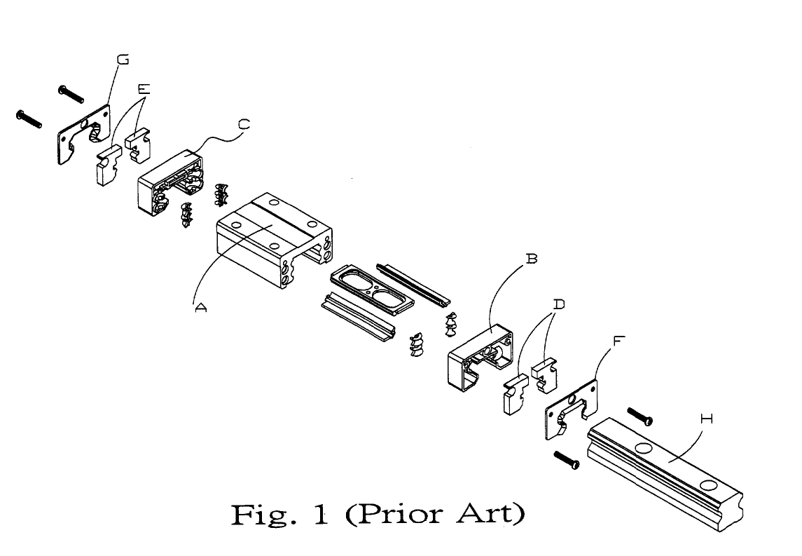

FIG. 2 is an exploded perspective view of the present invention.

FIG. 3 is an assembled perspective view of the present invention.

FIG. 4 shows one embodiment of the present invention.

FIG. 5 shows another embodiment of the present invention.

### BRIEF DESCRIPTION OF THE PREFERRED EMBODIMENTS

The lubricating device of an external oil storage tank of a self-lubricating linear sliding track of the present invention will be described herein with the appended drawings.

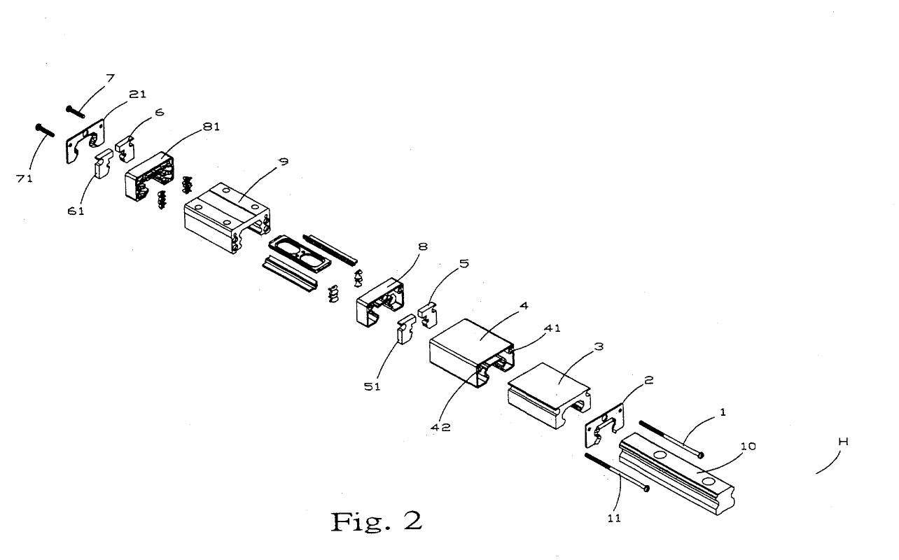

Referring to FIG. 2, the present invention is formed by an oil-containing element 3, an oil storage casing 4, a plurality of lubricating elements 5, 51, 6 and 61 and two dust-proof covers 2 and 21.

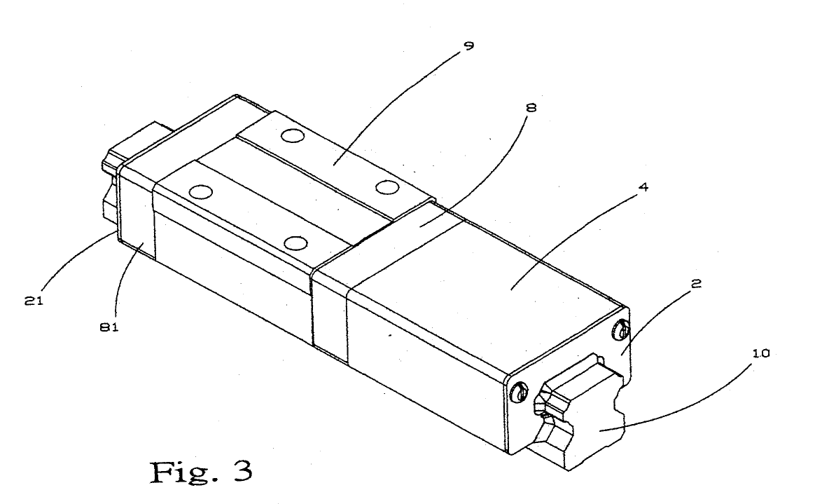

Two sides of the sliding block body 9 each have a lubricating means which is formed by an end circling outer covers 8, 81 containing lubricating elements 5, 51, 6, and 61. The lubricating elements 5, 51, 6, and 61 are in contact with the sliding track 10. An outer side of one lubricating means is installed with an oil storage tank. The oil storage tank has an oil storage casing 4 with two ends thereof being opened, and an oil-containing element 3 is placed in the oil storage casing 4. The oil-containing element 3 is not in contact with the sliding track 10. The dust-proof cover 2 seals an openings of the lubricating means containing an end circling outer covers 8, 81 and lubricating elements 5 and 51. Finally, the lock screws 1 and 11 lock the dust-proof cover 2 to the sliding block body so as to form a driving function (referring to FIG. 3).

By above device, the lubricating elements 5 and 51 will be in contact with the oil-containing element 3. By siphon effect, lubricating oil can be guided into the rolling surface and the rolling element of sliding track 10 so as to complete the lubricating function.

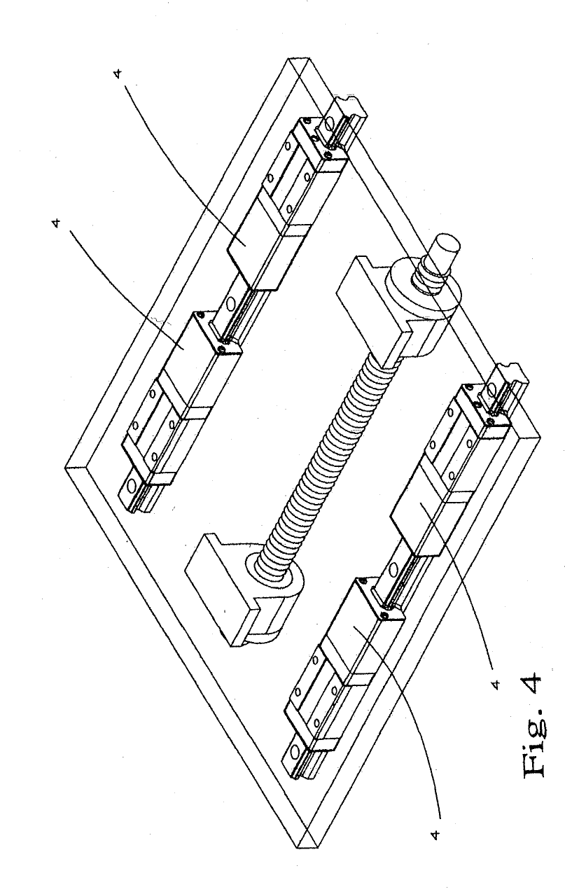

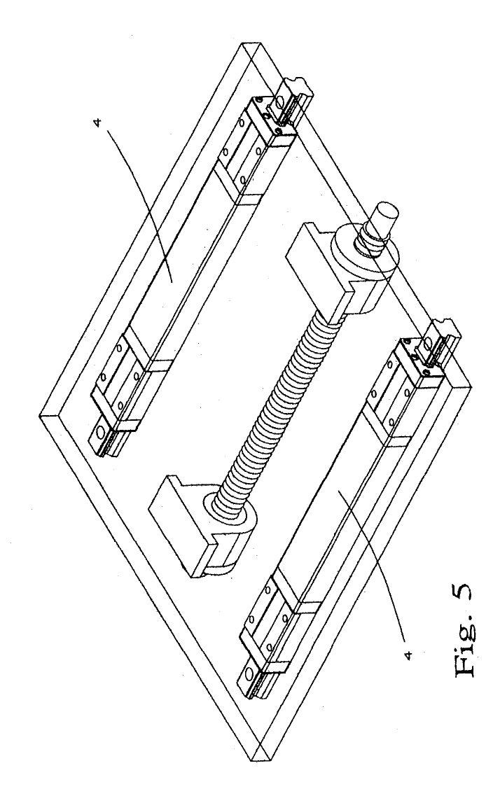

In summary, in the lubricating device of an external oil storage tank of a self-lubricating linear sliding track of the present invention, the oil-containing element is not in contact with the sliding track 10, and thus no lubricating oil will drain out. The lengths of the oil storage casing 4 and the oil-containing element 3 are adjustable based on the spaced sued (referring to FIGS. 4 and 5) without increasing cost. Thereby, the present invention matches the requirement of practice, improvement and environment protection.

Embodiment

One embodiment about the lubricating device of an external oil storage tank of a self-lubricating linear sliding track according to the present invention will be described herein. In the present invention, the end circling outer covers 8, 81, lubricating elements 5, 51, 6, and 61, oil storage casing 4, oil-containing element 3 and dust-proof cover 2 and 21 are locked to the sliding block body 9 by locking screws 1, 11, 7 and 71 so as to achieve the function of lubricating the rolling surface and rolling element of sliding tracks.

To be more understood the inventive step and use of the present invention, in the following, the present invention will be compared with the prior art.

The defects of the prior art are:

1. The lubricating device without any oil storage casing contains less oil and the cost in maintenance is high.

2. The external lubricating device has an inflexible oil storage space so that the space is confined.

3. The external lubricating device is in contact with the sliding track. The drainage of the lubricating oil is large and is not beneficial to environment protection.

4. The cost is high and thus it is not competitive.

Advantages of the present invention are:

1. The space for storing oil is large.

2. The space for storing oil is changeable based on usefulness and requirement, which is flexible and the cost is increased.

3. The lubricating oil will not lose and the present invention has a good effect in environment protection.

4. The assembly is easy and cost is low.

5. A space between two sliding block bodies can use a very large oil tank.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed:

1. A lubricating device of an external oil storage tank of a self-lubricating linear sliding track comprising a self-lubricating means and a oil storage tank; characterized in that:
two sides of a sliding block body are installed respective oil storage tanks; the oil storage tank has an oil storage casing with oil-containing material therein; wherein
a. the oil-containing material in the oil-containing tank is not in contact with a rolling surface of a sliding track;
b. two ends of the oil-containing tank are opened;
c. lubricating oil of the oil-containing material in the oil storage tank can be transferred to the sliding track by oil-containing material in the self-lubricating means by siphon effect so as to achieve an effect of lubrication; and
d. external oil tanks are installed between two sliding seat bodies for being used for a long time and has the function of dust-proof.

2. The lubricating device of an external oil storage tank of a self-lubricating linear sliding track as claimed in claim 1, wherein one opening at an outer side of the oil storage tank is sealed by an dust-proof cover and an opening at another side thereof is sealed by a self lubricating means; and locking devices are used to lock the dust-proof cover and the self-lubricating means.
